(19) United States
(12) Patent Application Publication
(10) Pub. No.: US 2019/0381439 A1
(43) Pub. Date: Dec. 19, 2019

(54) REAR COVER ASSEMBLY STRUCTURE FOR AIR PURIFIER AND AIR PURIFIER

(71) Applicant: HON HAI PRECISION INDUSTRY CO., LTD., New Taipei (TW)

(72) Inventors: CHIA-WEI LIU, New Taipei (TW); CHUN-KAI PENG, New Taipei (TW); YING-WEI SHENG, New Taipei (TW)

(21) Appl. No.: 16/391,716

(22) Filed: Apr. 23, 2019

(30) Foreign Application Priority Data
Jun. 14, 2018 (CN) 201810616258.2

(51) Int. Cl. B01D 46/00; H01F 7/02

(52) U.S. Cl. CPC B01D 46/0004; B01D 2265/02; H01F 7/02

(57) ABSTRACT

A rear cover assembly structure of an air purifier allows for rapid opening and demounting of a rear cover and includes a housing, the rear cover, a hooking mechanism, and a magnetic connection mechanism. The rear cover can be assembled on or detached from the housing by the hooking mechanism and the magnetic connection mechanism. The hooking mechanism includes a groove set on the housing and a shaft set on rear cover. The shaft being set in the groove or separated from the groove respectively locks or unlocks the hooking mechanism. The magnetic connection mechanism includes a magnetic assembly set on the housing and a metal sheet set on the rear cover, the metal sheet is attracted to the magnetic assembly. The metal sheet is set on the housing by a fixed structure of the housing.

### CROSS-REFERENCE TO RELATED APPLICATIONS

This application claims priority to Chinese Patent Application No. 201810616258.2 filed on Jun. 14, 2018, the contents of which is incorporated by reference herein.

### FIELD

The subject matter herein generally relates to demountable covers.

### BACKGROUND

A user needs to remove a rear cover from the air purifier to clean a screen of the air purifier. After cleaning the screen, the user must inconveniently reinstall the rear cover.

### BRIEF DESCRIPTION OF THE DRAWINGS

Implementations of the present technology will now be described, by way of embodiment, with reference to the attached figures.

FIG. 1 illustrates a schematic diagram of a rear cover assembly structure for an air purifier.

FIG. 2 is a schematic diagram illustrating a housing for the rear cover assembly structure of the air purifier of FIG. 1.

FIG. 3 is a schematic diagram illustrating a rear cover for the rear cover assembly structure of the air purifier of FIG. 1.

FIG. 4 is a diagram illustrating enlarged circular area IV of FIG. 2.

FIG. 5 is a sectional view of the magnetic connection mechanism of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

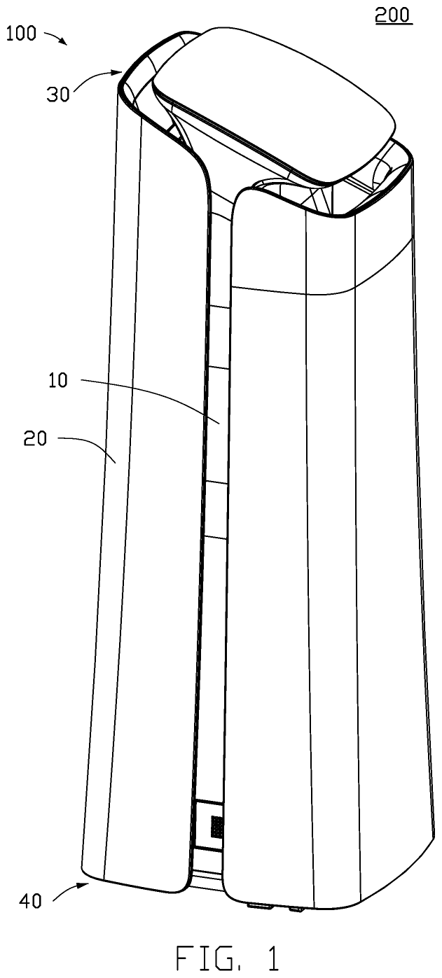

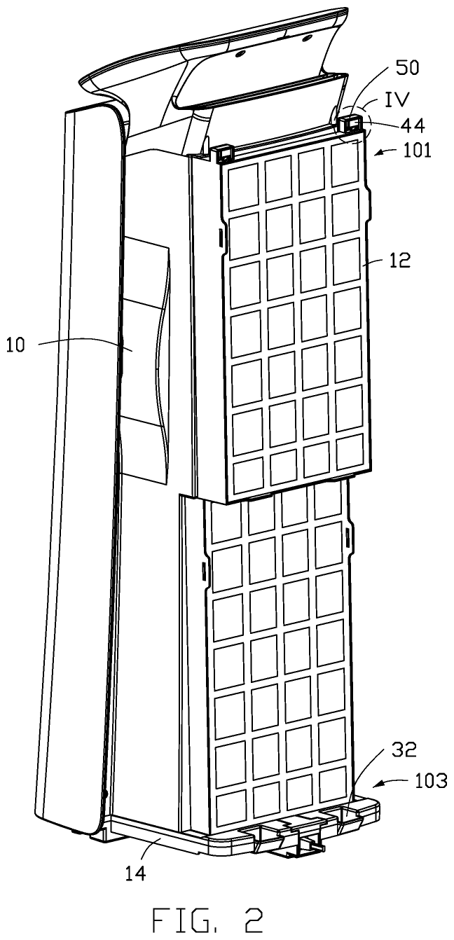

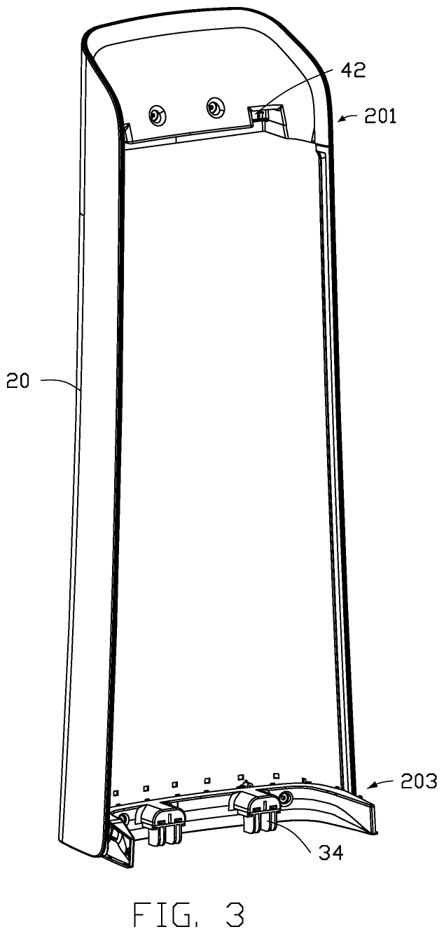

FIG. 1 illustrates an air purifier 200. The air purifier 200 includes the rear cover assembly structure 100. The rear cover assembly structure 100 for the air purifier 200 includes a housing 10, a rear cover 20, a hooking mechanism 30, and a magnetic connection mechanism 40. The rear cover 20 is opposite to the housing 10. The hooking mechanism 30 and the magnetic connection mechanism 40 are arranged between the housing 10 and the rear cover 20. The housing 10 is fixed to the rear cover 20 by the hooking mechanism 30 and the magnetic connection mechanism 40. The hooking mechanism 30 includes a groove 32 and a shaft 34, FIG. 2 illustrates the housing 10, and FIG. 3 illustrates the rear cover 20 in one embodiment. The groove 32 is set on the housing 10. The shaft 34 is set on the rear cover 20. In one embodiment, the magnetic connection mechanism 40 includes a magnetic assembly 42 and a metal sheet 44. The magnetic assembly 42 and the metal sheet 44 are set on the housing 10 and the rear cover 20. The metal sheet 44 is set on the housing 10 by a fixed structure 50 of the housing 10. In one embodiment, the hooking mechanism 30 and the magnetic connection mechanism 40, arranged between the housing 10 and the rear cover 20, represent the means for assembling and detaching the rear cover 20 to or from the housing 10. The shaft 34 can be set in the groove 32 or separated from the groove 32, to respectively lock or unlock the hooking mechanism 30. The metal sheet 44 attracts the magnetic assembly 42.

In one embodiment, the housing 10 includes a first upper end 101 and a first lower end 103. The rear cover 20 includes a second upper end 201 and a second lower end 203. In one embodiment, the first upper end 101 of the housing 10 faces the second upper end 201 of the rear cover 20. The first lower end 103 of the housing 10 faces the second lower end 203 of the rear cover 20. The magnetic assembly 42 and the metal sheet 44 are arranged between the first upper end 101 and the second upper end 201. The groove 32 and the shaft 34 are arranged between the first lower end 103 and the second lower end 203. In one embodiment, the first upper end 101 is arranged on a top part of a screen frame 12 of the housing 10. The first lower end 103 is arranged on a base plate 14 of the housing 10. In one embodiment, the second upper end 201 is arranged on a top part of the rear cover 20. The second lower part 203 is arranged on a bottom part of the rear cover 20.

In one embodiment, the first lower end 103 defines the groove 32 of the hooking mechanism 30, and the second lower end 203 defines the shaft 34 of the hooking mechanism 30. The shaft 34 can rotate in and be detached from the groove 32. In detail, when the shaft 34 is set in the groove 32, the rear cover 20 can be assembled on the housing 10. When the shaft 34 rotates in the groove 32, the rear cover 20 can rotate away from the housing 10 to open the rear cover 20. When the shaft 34 is separated from the groove 32, the rear cover 20 is separated from the housing 10.

In one embodiment, the magnetic assembly 42 and the metal sheet 44 of the magnetic connection mechanism 40 are arranged between the first upper end 101 and the second upper end 201. When the magnetic assembly 42 is set on the first upper end 101, the metal sheet 44 is set on the second upper end 201. When the magnetic assembly 42 is set on the second upper end 201, the metal sheet 44 is set on the first upper end 101. In one embodiment, the magnetic assembly 42 is set on the top part of the rear cover 20. The metal sheet 44 is set on the screen frame 12 of the housing 10. The rear cover 20 can be assembled on or separated from the housing 10 by attraction or separation between the magnetic assembly 42 and the metal sheet 44. In one embodiment, the magnetic assembly 42 is a magnetic module. The metal sheet 44 is an iron sheet. The magnetic module has a permanent magnet fixable directly on the first upper end 101. In prior art, the installation of the fixed structure 50 can be by screws, ultrasonic welding, or embedded injection molding. These processes have a complex procedure and a high implementation cost, and maintaining the stable position of the metal sheet 44 is problematic. In the present embodiment, the metal sheet 44 is installed in the fixed structure 50.

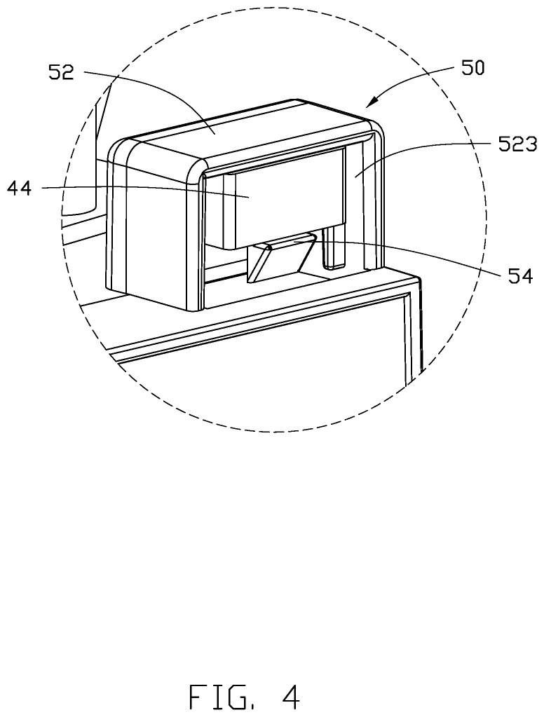

FIG. 4 illustrates the magnetic connection mechanism 40. In one embodiment, the fixed structure 50 includes a rib frame 52 and a hook buckle 54. The rib frame 52 defines a receiving space 521 and an opening 523. The metal sheet 44 is received in the receiving space 521 and is located in the opening 523. The hook buckle 54 is located at the outer lower edge of the opening 523. The hook buckle 54 limits upward and downward movements of the metal sheet 44 at the position of the opening 523. The rib frame 52 and the hook buckle 54 stabilize the metal sheet 44 at the position of the opening 523. In detail, the hook buckle 54 is positioned at the outer lower edge opposite to the outer upper edge of the opening 523. The outer lower edge of the opening 523 and the outer upper edge of the opening 523 constrain the position of the metal sheet 44 and keep it stable.

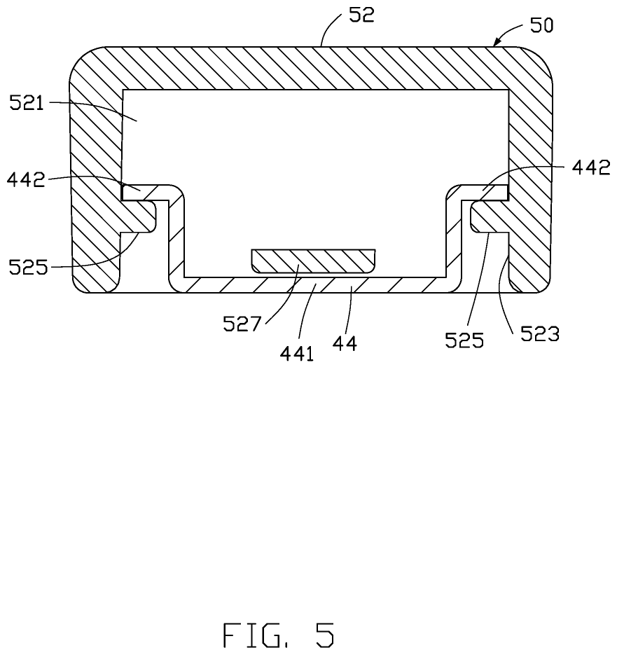

FIG. 5 illustrates the magnetic connection mechanism 40. The receiving space 521 of the rib frame 52 includes two first convex ribs 525 and a second convex rib 527. The two first convex ribs 525 are set on two side walls in the receiving space 521. The two side walls are opposite to each other. The second convex rib 527 is located at the central position of the opening 523. The metal sheet 44 in the receiving space 521 is arranged by the two first convex ribs 525 and the second convex rib 527. In one embodiment, the metal sheet 44 has a concave shape and the metal sheet 44 has a concavity 441 and two coupling ends 442. The two coupling ends 442 connect to the concavity 441. Each of the two coupling ends 442 rests on one of the two first convex ribs 525. The concavity 441 rests on the second convex rib 527. Therefore, the two side walls of the receiving space 521 limit leftward and rightward movements of the metal sheet 44 at the position of the opening 523. The two first convex ribs 525 and the second convex rib 527 limit forward and backward movements of the metal sheet 44 at the position of the opening 523. The hook buckle 54 limits upward and downward movements of the metal sheet 44 at the position of opening 523. Therefore, the position of the metal sheet 44 is limited by the rib frame 52 and the hook buckle 54 to hold the metal sheet 44 firmly in the fixed structure 50. The fixed structure 50 of the embodiment does not need secondary processing equipment or injection molding equipment. Convenience is improved and cost of application reduced.

When the shaft 34 of the hooking mechanism 30 rotates in the groove 32, the magnetic assembly 42 of the magnetic connection mechanism 40 can be separated from the metal sheet 44. When the shaft 34 is further separated upward from the groove 32, the rear cover 20 can be separated from the housing 10. When the shaft 34 is put in the groove 32 and rotated, the rear cover 20 can be assembled with the housing 10. In detail, when the rear cover 20 needs to be separated from the housing 10, user can pull off the rear cover 20 from upper end of the rear cover 20. The metal sheet 44 of the magnetic connection mechanism 40 is separated from the magnetic assembly 42, and the shaft 34 of the hooking mechanism 30 is separated from the groove 32, thus separating the rear cover 20 from the housing 10. When the rear cover 20 needs to be assembled with the housing 10, user can put the shaft 34 in the groove 34 of the housing 10 to buckle the hooking mechanism 30, and rotate the shaft 34 of the hooking mechanism 30 in the groove 32 to close the rear cover 20 against the housing 10. The rear cover 20 is held firmly in place on the housing 10 by the attraction between the magnetic assembly 42 and the metal sheet 44.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A rear cover assembly structure for air purifier comprising:
a housing;
a rear cover opposite to the housing;
a hooking mechanism arranged between the housing and the rear cover, the hooking mechanism comprising a groove defined in the housing and a shaft disposed on rear cover;
a magnetic connection mechanism arranged between the housing and the rear cover, the magnetic connection mechanism comprising a magnetic assembly disposed on the housing and a metal sheet disposed on the rear cover, the metal sheet being configured to attract the magnetic assembly, the metal sheet being set on the housing by a fixed structure of the housing;
wherein the shaft is capable of being received in the groove or separated from the groove to lock or unlock the hooking mechanism so that the rear cover is capable of being assembled on or detached from the housing.

2. The rear cover assembly structure for air purifier according to claim 1, wherein the rear cover comprises a second upper end and a second lower end, a first upper end of the housing faces the second upper end of the rear cover, a first lower end of the housing faces the second lower end of the rear cove, the magnetic assembly and the metal sheet are arranged between the first upper end and the second upper end, the groove and the shaft are arranged between the first lower end and the second lower end.

3. The rear cover assembly structure for air purifier according to claim 2, wherein the first upper end is arranged on a top part of a screen frame of the housing, the first lower end is arranged on a base plate of the housing, the second upper end is arranged on a top part of the rear cover, the second lower part is arranged on a bottom part of the rear cover.

4. The rear cover assembly structure for air purifier according to claim 2, wherein the first lower end defines the groove of the hooking mechanism, the second lower end defines the shaft of the hooking mechanism, the shaft can rotate in and be detached from the groove.

5. The rear cover assembly structure for air purifier according to claim 2, wherein the magnetic assembly and the metal sheet of the magnetic connection mechanism are arranged between the first upper end and the second upper end, the rear cover can be assembled on or separated from the housing by attraction or separation between the magnetic assembly and the metal sheet.

6. The rear cover assembly structure for air purifier according to claim 1, wherein the fixed structure comprises a rib frame and a hook buckle, the rib frame defines a receiving space and an opening, the metal sheet is received in the receiving space and is located in the opening, the hook buckle is located at the outer lower edge of the opening, the hook buckle limits upward movement and downward movement of the metal sheet at the position of opening, the rib frame and the hook buckle can stabilize the metal sheet at the position of the opening.

7. The rear cover assembly structure for air purifier according to claim 6, wherein the receiving space of the rib frame comprise two first convex ribs and a second convex rib, the two first convex ribs are set on two side walls in the receiving space, the two side walls are opposite to each other, the second convex rib is located at the central position of the opening, the metal sheet in the receiving space is arranged by the two first convex ribs and the second convex rib.

8. The rear cover assembly structure for air purifier according to claim 7, wherein the metal sheet has a concavity and two coupling ends, the two coupling ends connect to the concavity, each of the two coupling ends rests on one of the two first convex ribs, the concavity rests on the second convex rib.

9. The rear cover assembly structure for air purifier according to claim 7, wherein the two side walls of the receiving space limit leftward movement and rightward movement of the metal sheet at the position of the opening, the two first convex ribs and the second convex rib limit forward movement and backward movement of the metal sheet at the position of the opening.

10. The rear cover assembly structure for air purifier according to claim 1, wherein when the shaft of the hooking mechanism rotates in the groove, the magnetic assembly of the magnetic connection mechanism is separated from the metal sheet, and when the shaft rotating in the groove and the shaft is further separated upward from the groove, the rear cover is be separated from the housing.

11. An air purifier comprising:
A rear cover assembly structure, the rear cover assembly structure comprising:
a housing;
a rear cover opposite to the housing;
a hooking mechanism arranged between the housing and the rear cover, the hooking mechanism comprising a groove defined in the housing and a shaft disposed on rear cover;
a magnetic connection mechanism arranged between the housing and the rear cover, the magnetic connection mechanism comprising a magnetic assembly disposed on the housing and a metal sheet disposed on the rear cover, the metal sheet being configured to attract the magnetic assembly, the metal sheet being set on the housing by a fixed structure of the housing;
wherein the shaft is capable of being received in the groove or separated from the groove to lock or unlock the hooking mechanism so that the rear cover is capable of being assembled on or detached from the housing.

12. The air purifier according to claim 11, wherein the rear cover comprises a second upper end and a second lower end, a first upper end of the housing faces the second upper end of the rear cover, a first lower end of the housing faces the second lower end of the rear cove, the magnetic assembly and the metal sheet are arranged between the first upper end and the second upper end, the groove and the shaft are arranged between the first lower end and the second lower end.

13. The air purifier according to claim 12, wherein the first upper end is arranged on a top part of a screen frame of the housing, the first lower end is arranged on a base plate of the housing, the second upper end is arranged on a top part of the rear cover, the second lower part is arranged on a bottom part of the rear cover.

14. The air purifier according to claim 12, wherein the first lower end defines the groove of the hooking mechanism, the second lower end defines the shaft of the hooking mechanism, the shaft can rotate in and be detached from the groove.

15. The air purifier according to claim 12, wherein the magnetic assembly and the metal sheet of the magnetic connection mechanism are arranged between the first upper end and the second upper end, the rear cover can be assembled on or separated from the housing by attraction or separation between the magnetic assembly and the metal sheet.

16. The air purifier according to claim 11, wherein the fixed structure comprises a rib frame and a hook buckle, the rib frame defines a receiving space and an opening, the metal sheet is received in the receiving space and is located in the opening, the hook buckle is located at the outer lower edge of the opening, the hook buckle limits upward movement and downward movement of the metal sheet at the position of opening, the rib frame and the hook buckle can stabilize the metal sheet at the position of the opening.

17. The air purifier according to claim 16, wherein the receiving space of the rib frame comprise two first convex ribs and a second convex rib, the two first convex ribs are set on two side walls in the receiving space, the two side walls are opposite to each other, the second convex rib is located at the central position of the opening, the metal sheet in the receiving space is arranged by the two first convex ribs and the second convex rib.

18. The air purifier according to claim 17, wherein the metal sheet has a concavity and two coupling ends, the two coupling ends connect to the concavity, each of the two coupling ends rests on one of the two first convex ribs, the concavity rests on the second convex rib.

19. The air purifier according to claim 17, wherein the two side walls of the receiving space limit leftward movement and rightward movement of the metal sheet at the position of the opening, the two first convex ribs and the second convex rib limit forward movement and backward movement of the metal sheet at the position of the opening.

20. The air purifier according to claim 11, wherein when the shaft of the hooking mechanism rotates in the groove, the magnetic assembly of the magnetic connection mechanism is separated from the metal sheet, and when the shaft rotating in the groove and the shaft is further separated upward from the groove, the rear cover is be separated from the housing.
